(19) United States
(12) Patent Application Publication
(10) Pub. No.: US 2013/0211843 A1
(43) Pub. Date: Aug. 15, 2013

(54) ENGAGEMENT-DEPENDENT GESTURE RECOGNITION

(71) Applicant: QUALCOMM INCORPORATED, (US)

(72) Inventor: Ian Charles CLARKSON, North York (CA)

(73) Assignee: QUALCOMM INCORPORATED, San Diego, CA (US)

(21) Appl. No.: 13/765,668

(22) Filed: Feb. 12, 2013

Related U.S. Application Data
(60) Provisional application No. 61/598,280, filed on Feb. 13, 2012.

(51) Int. Cl. G06F 3/01

(52) U.S. Cl. CPC G06F 3/017
USPC 704/275; 345/156

(57) ABSTRACT

Methods, apparatuses, systems, and computer-readable media for performing engagement-dependent gesture recognition are presented. According to one or more aspects, a computing device may detect an engagement of a plurality of engagements, and each engagement of the plurality of engagements may define a gesture interpretation context of a plurality of gesture interpretation contexts. Subsequently, the computing device may detect a gesture. Then, the computing device may execute at least one command based on the detected gesture and the gesture interpretation context defined by the detected engagement. In some arrangements, the engagement may be an engagement pose, such as a hand pose, while in other arrangements, the detected engagement may be an audio engagement, such as a particular word or phrase spoken by a user.

### CROSS-REFERENCE TO RELATED APPLICATION

The present application is a non-provisional of and claims the benefit and priority under 35 U.S.C. 119(e) of U.S. Provisional App. No. 61/598,280 filed Feb. 13, 2012 entitled Engagement-Dependent Gesture Recognition, the entire contents of which are incorporated herein by reference for all purposes.

### BACKGROUND

Aspects of the disclosure relate to computing technologies. In particular, aspects of the disclosure relate to computing technologies in applications or devices capable of providing an active user interface, such as systems, methods, apparatuses, and computer-readable media that perform gesture recognition.

Increasingly, computing platforms such as smart phones, tablet computers, personal digital assistants (PDAs), televisions, as well as other devices, include touch screens, accelerometers, cameras, proximity sensors, microphones, and/or other sensors that may allow these devices to sense motion or other user activity serving as a form of user input. For example, many touch screen devices provide an interface whereby the user can cause specific commands to be executed by dragging a finger across the screen in an up, down, left or right direction. In these devices, a user action is recognized and a corresponding command is executed in response. Aspects of the present disclosure provide more convenient, intuitive, and functional gesture recognition interfaces.

### SUMMARY

Systems, methods, apparatuses, and computer-readable media for performing engagement-dependent gesture recognition are presented. In current gesture control systems, maintaining a library of simple dynamic gestures (e.g., a left swipe gesture, a right swipe gesture, etc., in which a user may move one or more body parts and/or other objects in a substantially linear direction and/or with a velocity sufficient to suggest the user's intent to perform the gesture) that can be performed by a user and recognized by a system may be a challenge. In particular, there may be only a limited number of “simple” gestures, and as gesture control systems begin to implement more complex gestures (such as having a user move their hand(s) in a triangle shape, for instance), it may be more difficult for users to perform all of the recognized gestures and/or it may take more time for a system to capture any particular gesture.

Another challenge that might arise in current gesture control systems is accurately determining when a user intends to interact with such a system—and when the user does not so intend. One way to make this determination is to wait for the user to input a command to activate or engage a gesture recognition mode, which may involve the user performing an engagement pose, using voice engagement inputs, or taking some other action. As discussed in greater detail below, an engagement pose may be a static gesture that the device recognizes as a command to enter a full gesture detection mode. In the full gesture detection mode, the device may seek to detect a range of gesture inputs with which the user can control the functionality of the device. In this way, once the user has engaged the system, the system may enter a gesture detection mode in which one or more gesture inputs may be performed by the user and recognized by the device to cause commands to be executed on the device.

In various embodiments described herein, a gesture control system on the device may be configured to recognize multiple unique engagement inputs. After detecting a particular engagement input and entering the full detection mode, the gesture control system may interpret subsequent gestures in accordance with a gesture interpretation context associated with the engagement input. For example, a user may engage the gesture control system by performing a hand pose which involves an outstretched thumb and pinky finger (e.g., mimicking the shape of a telephone), and which is associated with a first gesture input interpretation context. In response to detecting this particular hand pose, the device activates the first gesture interpretation context to which the hand pose corresponds. Under the first gesture interpretation context, a left swipe gesture may be linked to a “redial” command. Thus, if the device subsequently detects a left swipe gesture, it executes the redial command through a telephone application provided by the system.

Alternatively, a user may engage the full detection mode by performing a hand pose involving the thumb and index finger in a circle (e.g., mimicking the shape of a globe) which corresponds to a second gesture interpretation context. Under the second gesture interpretation context, a left swipe gesture may be associated with a scroll map command executable within a satellite application. Thus, when the thumb and index finger in a circle are used as an engagement gesture, the gesture control system will enter the full detection mode and subsequently interpret a left swipe gesture as corresponding to a “scroll map” command when the satellite navigation application is in use.

According to one or more aspects of the disclosure, a computing device may be configured to detect multiple distinct engagement inputs. Each of the multiple engagement inputs may correspond to a different gesture input interpretation context. Subsequently, the computing device may detect any one of the multiple engagement inputs at the time the input is provided by the user. Then, in response to user gesture input, the computing device may execute at least one command based on the detected gesture input and the gesture interpretation context corresponding to the detected engagement input. In some arrangements, the engagement input may take the form of an engagement pose, such as a hand pose. In other arrangements, the detected engagement may be an audio engagement, such as a user's voice.

According to one or more additional and/or alternative aspects of the disclosure, a computing device may remain in a limited detection mode until an engagement pose is detected. While in the limited detection mode, the device may ignore one or more detected gesture inputs. The computing device then detect an engagement pose and initiate processing of subsequent gesture inputs in response to detecting the engagement pose. Subsequently, the computing device may detect at least one gesture, and the computing device may further execute at least one command based on the detected gesture and the detected engagement pose.

According to one or more aspects, a method may comprise detecting an engagement of a plurality of engagements, where each engagement of the plurality of engagements defines a gesture interpretation context of a plurality of gesture interpretation contexts. The method may further comprise selecting a gesture interpretation context from amongst the plurality of gesture interpretation contexts. Further, the method may comprise detecting a gesture subsequent to detecting the engagement and executing at least one command based on the detected gesture and the selected gesture interpretation context. In some embodiments, the detection of the gesture is based on the selected gesture interpretation context. For example, one or more parameters associated with the selected gesture interpretation context are used for the detection. In some embodiments, potential gestures are loaded into a gesture detection engine based on the selected gesture interpretation context, or models for certain gestures may be selected or used or loaded based on the selected gesture interpretation context, for example.

According to one or more aspects, a method may comprise ignoring non-engagement sensor input until an engagement pose of a plurality of engagement poses is detected, detecting at least one gesture based on the sensor input subsequent to the detection of the engagement pose, and executing at least one command based on the detected gesture and the detected engagement pose. In some embodiments, each engagement pose of the plurality of engagement poses defines a different gesture interpretation context. In some embodiments, the method further comprises initiating processing of the sensor input in response to detecting the engagement pose, where the at least one gesture is detected subsequent to the initiating.

According to one or more aspects, a method may comprise detecting a first engagement, activating at least some functionality of a gesture detection engine in response to the detecting, detecting a gesture subsequent to the activating using the gesture detection engine, and controlling an application based on the detected first engagement and the detected gesture. In some embodiments, the activating comprises switching from a low power mode to a mode that consumes more power than the low power mode. In some embodiments, the activating comprises beginning to receive information from one or more sensors. In some embodiments, the first engagement defines a gesture interpretation context for the application. In some embodiments, the method further comprises ignoring one or more gestures prior to detecting the first engagement. In some embodiments, the activating comprises inputting data points obtained from the first engagement into operation of the gesture detection engine.

According to one or more aspects, a method may comprise detecting a first engagement, receiving sensor input related to a first gesture subsequent to the first engagement, and determining whether the first gesture is a command. In some embodiments, the first gesture comprises a command when the first engagement is maintained for at least a portion of the first gesture. The method may further comprise determining that the first gesture does not comprise a command when the first engagement is not held for substantially the entirety of the first gesture.

### BRIEF DESCRIPTION OF THE DRAWINGS

Aspects of the disclosure are illustrated by way of example. In the accompanying figures, like reference numbers indicate similar elements, and:

FIG. 1 illustrates an example device that may implement one or more aspects of the disclosure.

FIG. 2 illustrates an example timeline showing how a computing device may switch from a limited detection mode into a gesture detection mode in response to detecting an engagement pose in accordance with one or more illustrative aspects of the disclosure.

FIG. 3 illustrates an example method of performing engagement-dependent gesture recognition in accordance with one or more illustrative aspects of the disclosure.

FIG. 4 illustrates an example table of engagement poses and gestures that may be recognized by a computing device in accordance with one or more illustrative aspects of the disclosure.

FIG. 5 illustrates an example computing system in which one or more aspects of the disclosure may be implemented.

FIG. 6 illustrates a second example system for implementing one or more aspects of the present disclosure.

FIG. 7 is a flow diagram depicting an algorithm for implementing certain methods of the present disclosure, and may be used in conjunction with the example system of FIG. 6.

FIG. 8 is a flow diagram depicting example operations of a device configured to operate in accordance with techniques disclosed herein.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

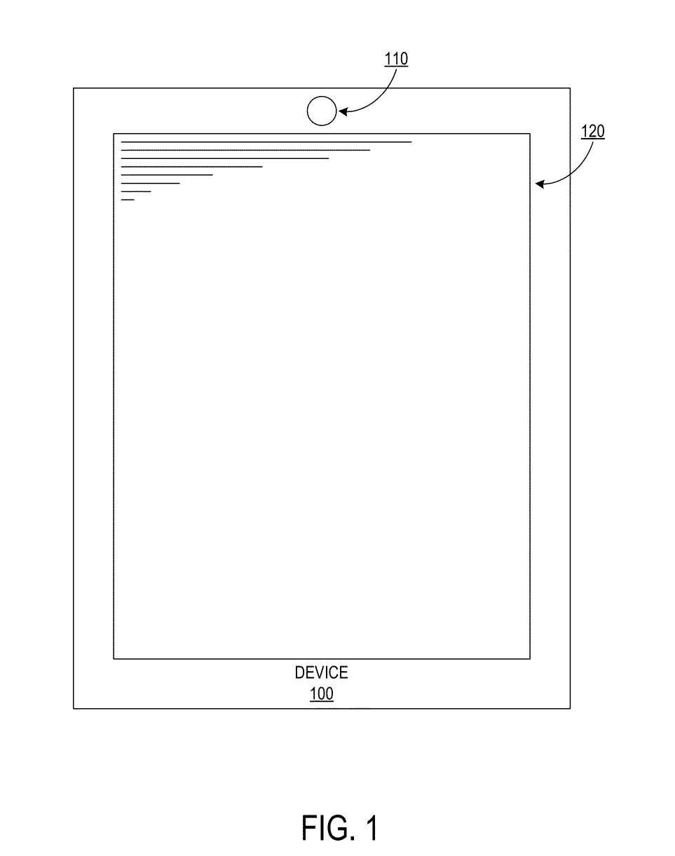

FIG. 1 illustrates an example device that may implement one or more aspects of the disclosure. For example, computing device 100 may be a personal computer, set-top box, electronic gaming console device, laptop computer, smart phone, tablet computer, personal digital assistant, or other mobile device that is equipped with one or more sensors that allow computing device 100 to capture motion and/or other sensed conditions as a form of user input. For instance, computing device 100 may be equipped with, communicatively coupled to, and/or otherwise include one or more cameras, microphones, proximity sensors, gyroscopes, accelerometers, pressure sensors, grip sensors, touch screens, and/or other sensors. In addition to including one or more sensors, computing device 100 also may include one or more processors, memory units, and/or other hardware components, as described in greater detail below. In some embodiments, the device 100 is incorporated into an automobile, for example in a central console of the automobile.

In one or more arrangements, computing device 100 may use any and/or all of these sensors alone or in combination to recognize gestures, for example gestures that may not include a user touching the device 100, performed by one or more users of the device. For example, computing device 100 may use one or more cameras, such as camera 110, to capture hand and/or arm movements performed by a user, such as a hand wave or swipe motion, among other possible movements. In addition, more complex and/or large-scale movements, such as whole body movements performed by a user (e.g., walking, dancing, etc.), may likewise be captured by the one or more cameras (and/or other sensors) and subsequently be recognized as gestures by computing device 100, for instance. In yet another example, computing device 100 may use one or more touch screens, such as touch screen 120, to capture touch-based user input provided by a user, such as pinches, swipes, and twirls, among other possible movements. While these sample movements, which may alone be considered gestures and/or may be combined with other movements or actions to form more complex gestures, are described here as examples, any other sort of motion, movement, action, or other sensor-captured user input may likewise be received as gesture input and/or be recognized as a gesture by a computing device implementing one or more aspects of the disclosure, such as computing device 100.

In some arrangements, for instance, a camera such as a depth camera may be used to control a computer or media hub based on the recognition of gestures or changes in gestures of a user. Unlike some touch-screen systems that might suffer from the deleterious, obscuring effect of fingerprints, camera-based gesture input may allow photos, videos, or other images to be clearly displayed or otherwise output based on the user's natural body movements or poses. With this advantage in mind, gestures may be recognized that allow a user to view, pan (i.e., move), size, rotate, and perform other manipulations on image objects.

A depth camera, such as a structured light camera or a time-of-flight camera, may include infrared emitters and a sensor. The depth camera may produce a pulse of infrared light and subsequently measure the time it takes for the light to travel to an object and back to the sensor. A distance may be calculated based on the travel time. As described in greater detail below, other input devices and/or sensors may be used to detect or receive input and/or assist in detected a gesture.

As used herein, a “gesture” is intended to refer to a form of non-verbal communication made with part of a human body, and is contrasted with verbal communication such as speech. For instance, a gesture may be defined by a movement, change or transformation between a first position, pose, or expression and a second pose, position, or expression. Common gestures used in everyday discourse include for instance, an “air quote” gesture, a bowing gesture, a curtsey, a cheek-kiss, a finger or hand motion, a genuflection, a head bobble or movement, a high-five, a nod, a sad face, a raised fist, a salute, a thumbs-up motion, a pinching gesture, a hand or body twisting gesture, or a finger pointing gesture. A gesture may be detected using a camera, such as by analyzing an image of a user, using a tilt sensor, such as by detecting an angle that a user is holding or tilting a device, or by any other approach. As those of skill in the art will appreciate from the description above and the further descriptions below, a gesture may comprise a non-touch, touchless, or touch-free gesture such as a hand movement performed in mid-air, for example. Such non-touch, touchless, or touch-free gestures may be distinguished from various “gestures” that might be performed by drawing a pattern on a touchscreen, for example, in some embodiments. In some embodiments, a gesture may be performed in mid-air while holding a device, and one or more sensors in the device such as an accelerometer may be used to detect the gesture.

A user may make a gesture (or “gesticulate”) by changing the position (i.e. a waving motion) of a body part, or may gesticulate while holding a body part in a constant position (i.e. by making a clenched first gesture). In some arrangements, hand and arm gestures may be used to control functionality via camera input, while in other arrangements, other types of gestures may additionally or alternatively be used. Additionally or alternatively, hands and/or other body parts (e.g., arms, head, torso, legs, feet, etc.) may be moved in making one or more gestures. For example, some gestures may be performed by moving one or more hands, while other gestures may be performed by moving one or more hands in combination with one or more arms, one or more legs, and so on. In some embodiments, a gesture may comprise a certain pose, for example a hand or body pose, being maintained for a threshold amount of time.

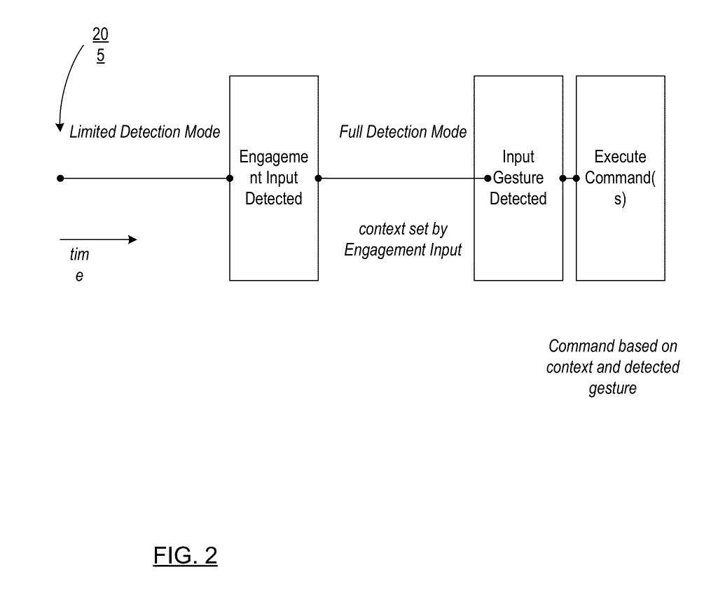

FIG. 2 illustrates an example timeline showing how a computing device may switch from a limited detection mode into a full detection mode in response to detecting an engagement input in accordance with one or more illustrative aspects of the disclosure. As seen in FIG. 2, at a start time 205, a computing device, such as device 100, may be in a limited detection mode. In the limited detection mode, the device processes sensor data to detect an engagement input. However, in this mode, the device may not execute commands associated with user inputs available for controlling the device in the full detection mode. In other words, only engagement inputs are valid in the limited detection mode in some embodiments.

Furthermore, the device may also be configured so that while it is in the limited detection mode, power and processing resources are not devoted to detecting inputs associated with the commands associated with the full detection mode. During the limited detection mode, the computing device might be configured to analyze sensor input (and/or any other input that might be received during this time) relevant to determining whether a user has provided an engagement input. In some embodiments, one or more sensors may be configured to be turned off or powered down, or to not provide sensor information to other components while the device 100 is in the limited detection mode.

As used herein, an “engagement input” refers to an input which triggers activation of the full detection mode. The full detection mode refers to a mode of device operation in which certain inputs may be used to control the functionality of the device, as determined by the active gesture interpretation context.

In some instances, an engagement input may be an engagement pose involving a user positioning his or her body or hand(s) in a particular way (e.g., an open palm, a closed fist, a “peace fingers” sign, a finger pointing at a device, etc.). In other instances, an engagement may involve one or more other body parts, in addition to and/or instead of the user's hand(s). For example, an open palm or closed first may constitute an engagement input when detected at the end of an outstretched arm in some embodiments.

Additionally or alternatively, an engagement input may include an audio input such as a sound which triggers the device to enter the full gesture detection mode. For instance, an engagement input may be a user speaking a particular word or phrase which the device is configured to recognize as an engagement input. In some embodiments, an engagement input may be provided by a user occluding a sensor. For example, a device could be configured to recognize when the user blocks the field of view of a camera or the transmitting and/or receiving space of a sonic device. For example, a user traveling in an automobile may provide an engagement input by occluding a camera or other sensor present in the car or on a handheld device.

Once the computing device determines that an engagement input has been detected, the device enters a full detection mode. In one or more arrangements, the particular engagement input that was detected by the device may correspond to and trigger a particular gesture interpretation context. A gesture interpretation context may comprise a set of gesture inputs recognizable by the device when the context is engaged, as well as the command(s) activated by each such gesture. Thus, during full detection mode, the active gesture interpretation context may dictate the interpretation given by a device to detected gesture inputs. Furthermore, in full detection mode, the active gesture interpretation context may itself be dictated by the engagement input which triggered the device to enter the full detection mode. In some embodiments, a “default” engagement may be implemented that will allow the user to enter a most recent gesture interpretation context, for example rather than itself being associated with a unique gesture interpretation context.

Continuing to refer to FIG. 2, once the computing device has entered the full detection mode, the computing device may detect one or more gestures. In response to detecting a particular gesture, the device may interpret the gesture based on the gesture interpretation context corresponding to the most recent engagement input. The recognizable gestures in the active gesture interpretation context may each be associated with a command. In this way, when any one of the gestures is detected as input, the device determines the command with which the gesture is associated, and executes the determined command. In some embodiments, the most recent engagement input may not only determine which commands are associated with which gestures, but the engagement input may be used to determine one or more parameters used to detect one or more of those gestures.

As an example implementation of the previously described methodology, a device could recognize a pose involving a user's thumb and outstretched pinky finger, and could associate this pose with a telephonic gesture interpretation context. The same device could also recognize a hand pose involving a thumb and forefinger pressed together in a circle, and could associate this pose with a separate navigational gesture interpretation context applicable to mapping applications.

If this example computing device detected an engagement that included a hand pose involving a user's thumb and outstretched pinky finger, then the device may interpret gestures detected during the gesture detection mode in accordance with a telephonic gesture interpretation context. In this context, if the computing device were to then recognize a left swipe gesture, the device may interpret the gesture as a “redial” command to be executed using a telephone application (e.g., a telephonic software application) provided by the device, for example. On the other hand, in this example, if the computing device recognized an engagement that included a hand pose in which the user's thumb and index finger form a circle (e.g., mimicking the shape of a globe), then the device may interpret gestures detected during the gesture detection mode in accordance with a navigational gesture interpretation context. In this context, if the computing device were to then recognize a left swipe gesture, the device may interpret the gesture as a “scroll map” command to be executed using a satellite navigation application (e.g., a satellite navigation software application) also provided by the device, for example. As suggested by these examples, in at least one embodiment, the computing device may be implemented as and/or in an automobile control system, and these various engagements and gestures may allow the user to control different functionalities of the automobile control system.

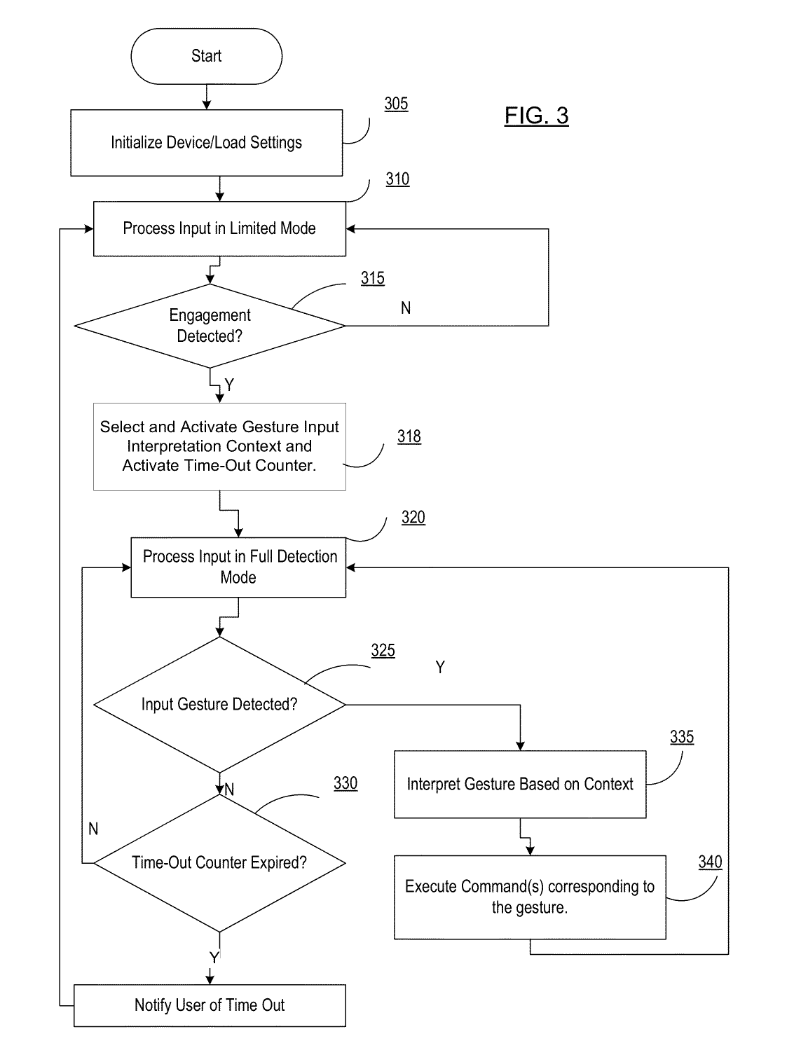

FIG. 3 illustrates an example method of performing engagement-dependent gesture recognition in accordance with one or more illustrative aspects of the disclosure. According to one or more aspects, any and/or all of the methods and/or method steps described herein may be implemented by and/or in a computing device, such as computing device 100 and/or the computer system described in greater detail below, for instance. In one embodiment, one or more of the method steps described below with respect to FIG. 3 are implemented by a processor of the device 100. Additionally or alternatively, any and/or all of the methods and/or method steps described herein may be implemented in computer-readable instructions, such as computer-readable instructions stored on a computer-readable medium. Moreover, in accordance with the present disclosure, a device may incorporate other steps, calculations, algorithms, methods, or actions which may be needed for the execution of any of the steps, decisions, determinations and actions depicted in FIG. 3.

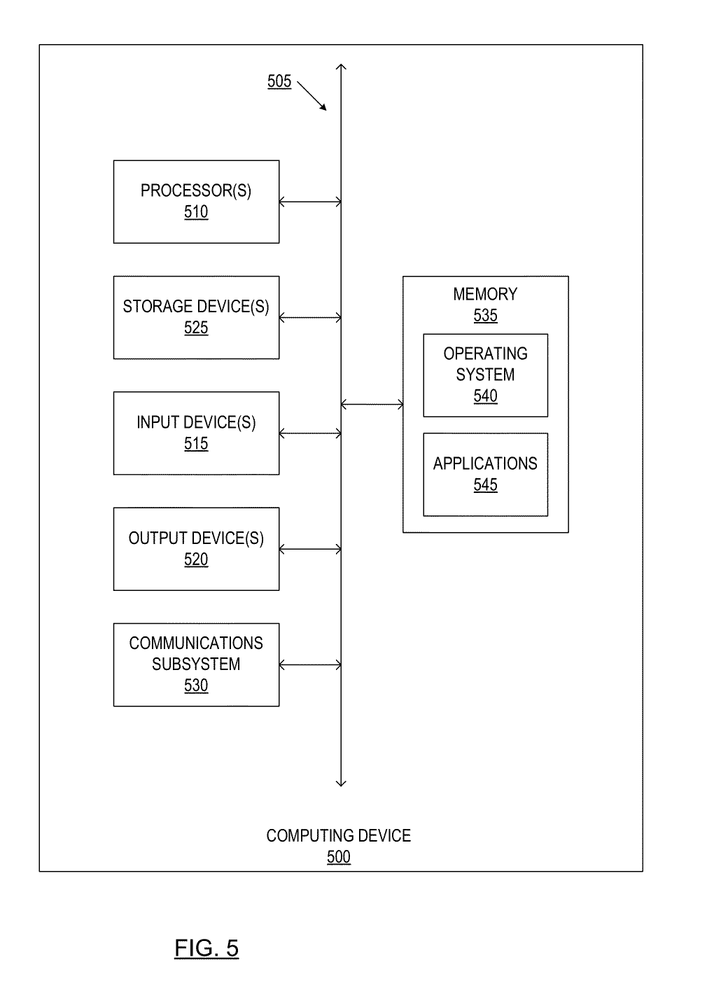

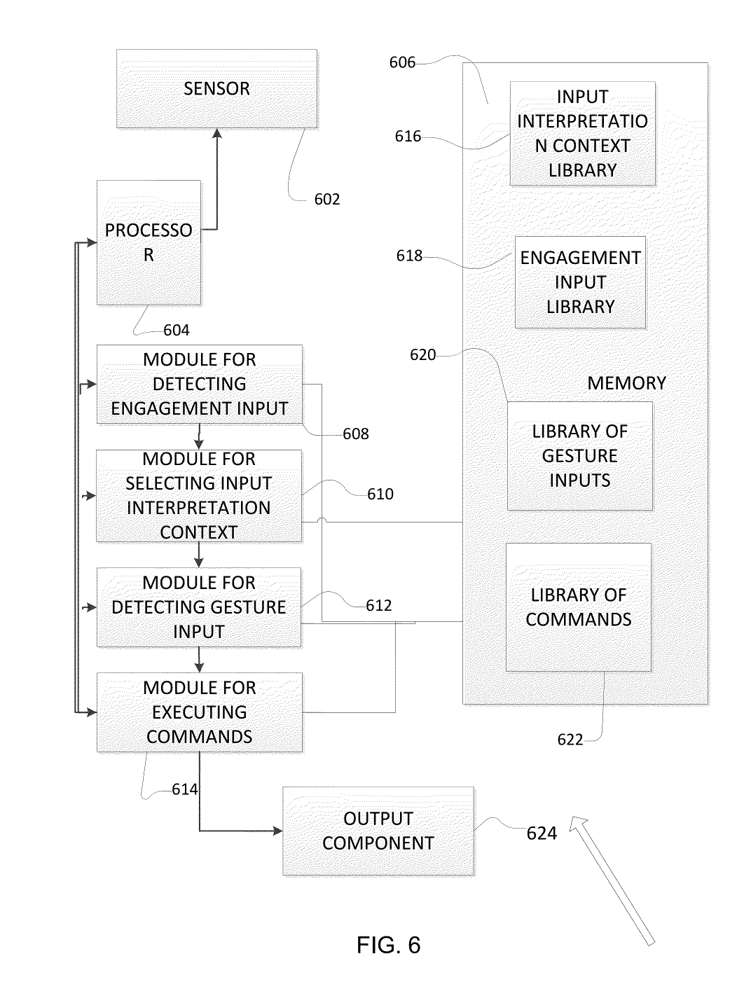

In conjunction with a description of the method of FIG. 3, subsequent paragraphs will refer ahead to FIGS. 5 and 6 to indicate certain components of these figures which may be associated with the method steps. In step 305, a computing device, such as a computing device capable of recognizing one or more gestures as user input (e.g., computing device 500 or 600), may be initialized, and/or one or more settings may be loaded. For example, when the computing device is first powered on, the device (in association with software stored and/or executed thereon, for instance) may load one or more settings, such as user preferences related to gestures. In at least one arrangement, these user preferences may include gesture mapping information in which particular gestures are mapped to particular commands in different gesture interpretation contexts. Additionally or alternatively, such gesture mapping information may specify the engagement inputs and the different gesture interpretation contexts brought about by each such engagement input. Information related to gesture mapping settings or the like may be stored in memory 535 or memory 606, for example.

In one or more additional and/or alternative arrangements, the settings may specify that engagement inputs operate at a “global” level, such that these engagement inputs correspond to the same gesture interpretation context regardless of the application currently “in focus” or being used. On the other hand, the settings may specify that other engagement inputs operate at an application level, such that these engagement inputs correspond to different gestures at different times, with the correspondence depending on which application is being used. The arrangement of global and application level engagement inputs may depend on the system implementing these concepts and a system may be configured with global and application level engagement inputs as needed to suit the specific system design objectives. The arrangement of global and application level engagement inputs may also be partially or entirely determined based on settings provided by the user.

For instance, the following table (labeled “Table A” below) illustrates an example of the gesture mapping information that may be used in connection with a system implementing one or more aspects of the disclosure in an automotive setting:

TABLE A

| Focus | Engagement | Context | Gesture | Command |
|---|---|---|---|---|
| Any | Phone Hand | Global: | Left Swipe | Redial |
| | Pose | Telephone | | |
| | | Application | | |
| Any | Phone Hand | Global: | Downward | Hang Up |
| | Pose | Telephone | Swipe | |
| | | Application | | |
| Any | Globe Hand | Global: | Left Swipe | Scroll |
| | Pose | Navigation | | Map Left |
| | | Application | | |
| Any | Globe Hand | Global: | Right Swipe | Scroll |
| | Pose | Navigation | | Map Right |
| | | Application | | |
| Any | Globe Hand | Global: | Upward | Center Map |
| | Pose | Navigation | Swipe | |
| | | Application | | |
| Any | Globe Hand | Global: | Downward | Navigate |
| | Pose | Navigation | Swipe | Home |
| | | Application | | |
| Navigation | Open Palm | Navigation | Left Swipe | Scroll |
| Application | | Application: | | Map Left |
| | | Scroll Level | | |
| Navigation | Open Palm | Navigation | Right Swipe | Scroll |
| Application | | Application: | | Map Right |
| | | Scroll Level | | |
| Navigation | Closed Fist | Navigation | Left Swipe | Zoom In |
| Application | | Application: | | |
| | | Zoom Level | | |
| Navigation | Closed Fist | Navigation | Right Swipe | Zoom Out |
| Application | | Application: | | |
| | | Zoom Level | | |
| Telephone | Open Palm | Telephone | Left Swipe | Next Contact |
| Application | | Application: | | |
| | | Contact Level | | |
| Telephone | Closed Fist | Telephone | Left Swipe | Next Group |
| Application | | Application: | | of Contacts |
| | | Group Level | | |

As another example, the following table (labeled “Table B” below) illustrates an example of the gesture mapping information that may be used in connection with a system implementing one or more aspects of the disclosure in a home entertainment system setting:

TABLE B

| Focus | Engagement | Context | Gesture | Command |
|---|---|---|---|---|
| Main | Open Palm | Main Menu: | Left Swipe | Scroll to Next |
| Menu | | Item Level | | Menu Item |
| Main | Open Palm | Main Menu: | Right Swipe | Scroll to |
| Menu | | Item Level | | Previous Menu |
| | | | | Item |
| Main | Closed Fist | Main Menu: | Left Swipe | Scroll to Next |
| Menu | | Page Level | | Page of Items |
| Main | Closed Fist | Main Menu: | Right Swipe | Scroll to Next |
| Menu | | Page Level | | Page of Items |
| Audio | Open Palm | Audio Player: | Left Swipe | Play Next Track |
| Player | | Track Level | | |
| Audio | Closed Fist | Audio Player: | Left Swipe | Play Next |
| Player | | Album Level | | Album |
| Video | Open Palm | Video Player: | Left Swipe | Fast Forward |
| Player | | Playback | | |
| | | Control | | |
| Video | Closed Fist | Video Player: | Left Swipe | Next |
| Player | | Navigation | | Scene/Chapter |
| | | Control | | |

Table A and B are provided for example purposes only and alternative or additional mapping arrangements, commands, gestures, etc. may be used in a device employing gesture recognition in accordance with this disclosure.

Many additional devices and applications may also be configured to use gesture detection and gesture mapping information in which particular gestures are mapped to particular commands in different gesture interpretation contexts. For example, a television application interface may incorporate gesture detection to enable users to control the television. A television application may incorporate gesture interpretation contexts in which a certain engagement input facilitates changing the television channel with subsequent gestures, while a different engagement input facilitates changing the television volume with subsequent gestures.

As an additional example, a video game application may be controlled by a user through gesture detection. A gesture input interpretation context for the video game may include certain gesture inputs mapped to “pause” or “end” control commands, for example similar to how the video game may be operated at a main menu (i.e. main menu is the focus). A different interpretation context for the video game may include the same or different gesture inputs mapped to live game control commands, such as shooting, running, or jumping commands.

Moreover, for a device which incorporates more than one user application, a gesture interpretation context may facilitate changing an active application. For example, a gesture interpretation context available during use of a GPS application may contain mapping information tying a certain gesture input to a command for switching to or additionally activating another application, such as a telephone or camera application.

In step 310, the computing device may process input in the limited detection mode. For example, in step 310, computing device 100 may be in the limited detection mode in which sensor input may be received and/or captured by the device, but processed only for the purpose of detecting engagement inputs. Prior to processing, sensor input may be received by input device 515 or sensor 602. In certain embodiments, while a device operates in the limited detection mode, gestures that correspond to the commands recognized in the full detection mode may be ignored or go undetected. Furthermore, the device may deactivate or reduce power to sensors, sensor components, processor components, or software modules which are not involved in detecting engagement inputs. For example, in a device in which the engagement inputs are engagement poses, the device may reduce power to a touchscreen or audio receiver/detector components while using the camera to detect the engagement pose inputs. As noted above, operating in this manner may be advantageous when computing device 100 is relying on a limited power source, such as a battery, as processing resources (and consequently, power) may be conserved during the limited detection mode.

Subsequently, in step 315, the device may determine whether an engagement input has been provided. This step may involve computing device 100 continuously or periodically analyzing sensor information received during the limited detection mode to determine if an engagement input (such as an engagement pose or audio engagement described above) has been provided. More specifically, this analysis may be performed by a processor such as the processor 510, in conjunction with memory device(s) 525. Alternatively, a processor such as processor 604 may be configurable to perform the analysis in conjunction with module 608. Until the computing device detects an engagement input, at step 315, it may remain in the limited detection mode as depicted by the redirection arrow pointing to step 310, and continues to process input data for the purpose of detecting an engagement input.

On the other hand, if the computing device detects an engagement input at step 315, the device selects and may activate a gesture input interpretation context based on the engagement input, and may commence a time-out counter, as depicted at 318. More specifically, selection and activation of a gesture interpretation context may be performed by a processor such as the processor 510, in conjunction with memory device(s) 525. Alternatively, a processor such as processor 604 may be configurable to perform the selection and activation, in conjunction with module 610.

The computing device may be configured to detect several possible engagement inputs at 315. In certain embodiments of the present disclosure, the computing device may be configured to detect one or more engagement inputs associated with gesture input interpretation contexts in which both static poses and dynamic gestures are recognizable and are mapped to control commands. Information depicting each engagement input (e.g. each hand pose, gesture, swipe, movement, etc.) detectable by the computing device may be accessibly stored within the device, as will be explained with reference to subsequent figures. This information may be directly determined from model engagement inputs provided by the user or another person. Additionally or alternatively, the information could be based on mathematical models which quantitatively depict the sensor inputs expected to be generated by each of the engagement inputs. Furthermore, in certain embodiments, the information could be dynamically altered and updated based on an artificial intelligence learning process occurring inside the device or at an external entity in communication with the device.

Additionally, information depicting the available gesture interpretation contexts may be stored in memory a manner which associates each interpretation context with at least one engagement input. For example, the device may be configured to generate such associations through the use of one or more lookup tables or other storage mechanisms which facilitate associations within a data storage structure.

Then, at 320, the device enters the full detection mode and processes sensor information to detect gesture inputs, as indicated at step 320. For example, in step 320, computing device 100 may capture, store, analyze, and/or otherwise process sensor information to detect the gesture inputs relevant within the active gesture interpretation context. In one or more additional and/or alternative arrangements, in response to determining that an engagement has been detected, computing device 100 may further communicate to the user an indication of the gesture inputs available within the active gesture interpretation context and the commands which correspond to each such gesture input.

Additionally or alternatively, in response to detecting an engagement input, computing device 100 may play a sound and/or otherwise provide audio feedback to indicate activation of the gesture input interpretation context associated with the detected engagement. For example, the device may provide a “telephone dialing” sound effect upon detecting an engagement input associated with a telephonic context or a “twinkling stars” sound effect upon detecting an engagement gesture associated with a satellite navigational gesture input interpretation context.

Also, a device may be configured to provide a visual output indicating detection of an engagement gesture associated with a gesture input interpretation context. A visual output may be displayed on a screen or through another medium suitable for displaying images or visual feedback. As an example of a visual indication of a gesture interpretation context, a device may show graphical depictions of certain of the hand poses or gestures recognizable in the interpretation context and a description of the commands to which the gestures correspond.

In some embodiments, after an engagement is detected in step 315, a gesture input detection engine may be initialized as part of step 320. Such initialization may be performed, at least in part, by a processor such as processor 604. The initialization of the gesture input detection engine may involve the processor 604 activating a module for detecting gesture inputs such as the one depicted at 612. The initialization may further involve processor 604 accessing information depicting recognizable engagement inputs. Such information may be stored in engagement input library 618, or in any other storage location.

In some embodiments, as part of the process of detecting an engagement input at 315, the device may obtain information about the user or the environment surrounding the device. Such information may be saved and subsequently utilized in the full detection mode by the gesture detection engine or during the processing in step 320 and/or in step 325, for example to improve gesture input detection. In some embodiments, when an engagement input involving a hand pose is detected at step 315, the device 100 extracts features or key points of the hand that may be used to subsequently track hand motion in step 320 in order to detect a gesture input in full detection mode.

At step 325, the computing device 100, now in the full detection mode, determines whether an actionable gesture input has been provided by the user. By way of example, as part of performing step 325, computing device 600 may continuously or periodically analyze sensor data to determine whether a gesture input associated with the active interpretation context has been provided. In the case of computing device 600, such analysis may be performed by processor 604 in conjunction with module 612 and the library of gesture inputs 620.

In one embodiment of the present disclosure, the full detection mode may only last for a predetermined period of time (e.g., 10 seconds or 10 seconds since the last valid input was detected), such that if an actionable gesture input is not detected within such time, the gesture detection mode “times out” and the device returns to the limited detection mode described above. This “time out” feature is depicted in FIG. 3 at 318, and may be implemented using a time lapse counter which, upon reaching a time limit or expiring, triggers cancellation of the full detection mode and re-initialization of the limited detection mode. When such a counter is used, the counter may be configured to start as soon as a detected engagement input is no longer detected, as shown by step 318. In this way, a user can hold an engagement pose or other such input and then delay in deciding upon an input gesture, without the gesture detection mode timing out before the user provides the gesture input.

In some embodiments, the user may perform a certain gesture or another predefined engagement that “cancels” a previously provided engagement input, thereby allowing the user to reinitialize the time out counter or change gesture interpretation contexts without having to wait for the time out counter to expire.

As depicted in FIG. 3, if the computing device determines, at step 325, that a gesture has not yet been detected, then in step 330, the computing device determines if the time-out counter has expired. If the counter has expired, the device notifies the user that the full detection mode has timed out (e.g., by displaying a user interface, playing a sound, etc.), and subsequently reenters the limited detection mode, as depicted by the return arrow to step 310. If the time-out counter has not yet expired, the device continues to process sensor information in the full detection mode, as depicted by the return arrow to step 320.

If, at any time while in the full detection mode, the computing device detects an actionable gesture input (i.e. a gesture input that is part of the active gesture interpretation context) at step 325, then at step 335, the computing device interprets the gesture based on the active gesture input interpretation context. Interpreting the gesture may include determining which command(s) should be executed in response to the gesture in accordance with the active gesture input interpretation context. As discussed above, different contexts (corresponding to different engagements) may allow for control of different functionalities, the use of different gestures, or both. For instance, a navigational context may allow for control of a navigation application, while a telephonic context may allow for control of a telephone application.

In certain embodiments of the present invention, the detection of engagement inputs in the limited detection mode and/or selection of an interpretation context may be independent of the location at which the user provides the engagement input. In such cases, the device may be configured to activate the full detection mode and a gesture interpretation context regardless of the position relative to the device sensor at which the engagement input is detected. Additionally or alternatively, the device may be configured so that detection of input gestures in the full detection mode is independent of the position at which the gesture input is provided. Further, when elements are being displayed, for example on the screen 120, detection of an engagement input and/or selection of an input interpretation context may be independent of what is being displayed.

Certain embodiments of the present invention may involve gesture input interpretation contexts having only one layer of one-to-one mapping between inputs and corresponding commands. In such a case, all commands may be available to the user through the execution of only a single gesture input. Additionally or alternatively, the gesture input interpretation contexts used by a device may incorporate nested commands which cannot be executed unless a series of two consecutive gesture inputs are provided by the user. For example, in an example gesture input interpretation context incorporating single layer, one-to-one command mapping, an extended thumb and forefinger gesture input may directly correspond to a command for accessing a telephone application. In an example system in which nested commands are used, a gesture input involving a circular hand pose may directly correspond to a command to initialize a navigation application. Subsequent to the circular hand pose being provided as gesture input, an open palm or closed fist may thereafter correspond to a functional command within the navigation application. In this way, the functional command corresponding to the open palm is a nested command, and an open palm gesture input may not cause the functional command to be executed unless the circular hand pose has been detected first.

Additional embodiments may involve the device being configured to be operate based on nested engagement inputs. For example, a device using nested engagement inputs may be configured to recognize a first and second engagement input, or any series of engagement inputs. Such a device may be configured so as to not enter the full detection mode until after a complete series of engagement.

A device capable of operations based on nesting of engagement inputs may enable a user to provide a first engagement input indicating an application which the user desires to activate. A subsequent engagement input may then specify a desired gesture interpretation context associated with the indicated application. The subsequent engagement input may also trigger the full detection mode, and activation of the indicated application and context. The device may be configured to respond to the second engagement input in a manner dictated by the first detected engagement input. Thus, in certain such device configurations, different engagement input sequences involving identical second engagement inputs may cause the device to activate different gesture input interpretation contexts.

At step 340, the device may execute the one or more commands which, in the active gesture input interpretation context, correspond to the previously detected gesture input. As depicted by the return arrow shown after step 340, the device may then return to processing sensor information at step 320, while the active gesture input interpretation context is maintained. In some embodiments, the time-out counter is reset at 340 or 320. Alternatively, the device may return to the limited detection mode or some other mode of operation.

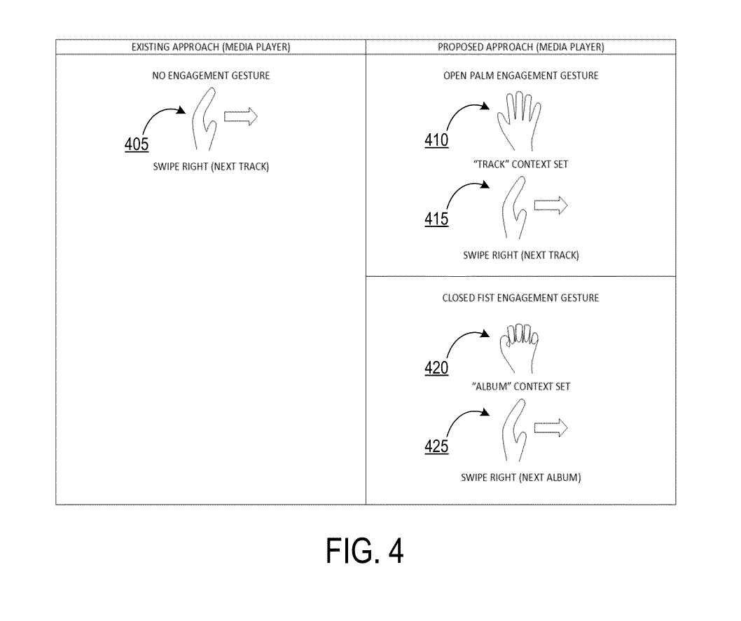

FIG. 4 illustrates an example table of engagement poses and gestures that may be recognized by a computing device in accordance with one or more illustrative aspects of the disclosure. As seen in FIG. 4, in some existing approaches, a “swipe right” gesture 405 may cause a computing device to execute a “next track” command within a media player application.

In one or more embodiments, however, by first performing an engagement, such as an “open palm” engagement pose 410 or a “closed fist” engagement pose 420, the same gesture may be mapped to different functions depending on the context set by the engagement pose. As seen in FIG. 4, for instance, if a user performs an “open palm” engagement pose 410 and then performs a “swipe right” gesture 415, the computing device may execute a “next track” command within the media player based on a track-level control context set by the “open palm” engagement pose 410. On the other hand, if a user performs a “closed fist” engagement pose 420 and then performs a “swipe right” gesture 425, the computing device may execute a “next album” command within the media player based on the album-level control context set by the “closed first” engagement pose 420.

Having described multiple aspects of engagement-dependent gesture recognition, an example of a computing system in which various aspects of the disclosure may be implemented will now be described with respect to FIG. 5. According to one or more aspects, a computer system as illustrated in FIG. 5 may be incorporated as part of a computing device, which may implement, perform, and/or execute any and/or all of the features, methods, and/or method steps described herein. For example, a handheld device may be entirely or partially composed of a computer system 500. The hand-held device may be any computing device with sensor capable of sensing user inputs, such as a camera and/or a touchscreen display unit. Examples of a hand-held device include but are not limited to video game consoles, tablets, smart phones, and mobile devices. The system 500 of FIG. 5 is one of many structures which may be used implement some or all of the features and methods described previously with regards to the device 100.

In accordance with the present disclosure, the structure depicted in FIG. 5 may be used within a host computer system, a remote kiosk/terminal, a point-of-sale device, a mobile device, a set-top box, or any other type of computer system configured to detect user inputs. FIG. 5 is meant only to provide a generalized illustration of various components, any and/or all of which may be utilized as appropriate. FIG. 5, therefore, broadly illustrates how individual system elements may be implemented and is not intended to depict that all such system elements must be disposed in in integrated manner. In accordance with this disclosure, system components such as the ones shown in FIG. 5 may be incorporated within a common electrical structure, or may be located in separate structures. Although certain of these components are depicted as hardware, the components are not to be so limited, and may be embodied in or exist as software, processor modules, one or more micro-control devices, logical circuitry, algorithms, remote or local data storage, or any other suitable devices, structures, or implementations known in the arts relevant to user input detection systems.

The computer system 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, and/or the like); one or more input devices 515, which can include without limitation a camera, a mouse, a keyboard and/or the like; and one or more output devices 520, which can include without limitation a display unit, a printer and/or the like. The bus 505 may also provide communication between cores of the processor 510 in some embodiments.

The computer system 500 may further include (and/or be in communication with) one or more non-transitory storage devices 525, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 500 might also include a communications subsystem 530, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 530 may permit data to be exchanged with a network (such as the network described below, to name one example), other computer systems, and/or any other devices described herein. In many embodiments, the computer system 500 will further comprise a non-transitory working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIG. 3, might be implemented as code and/or instructions executable by a computer (and/or a processor within a computer); in an aspect, then, such code and/or instructions can be used to configure and/or adapt a general purpose computer (or other device) to perform one or more operations in accordance with the described methods. The processor 510, memory 535, operating system 540, and/or application programs 545 may comprise a gesture detection engine, as discussed above, and/or may be used to implement any or all of blocks 305-340 described with respect to FIG. 3.

A set of these instructions and/or code might be stored on a computer-readable storage medium, such as the storage device(s) 525 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 500) to perform methods in accordance with the disclosure. For example, some or all of the procedures of the described methods may be performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein, for example a method described with respect to FIG. 3.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 525. Volatile media include, without limitation, dynamic memory, such as the working memory 535. Transmission media include, without limitation, coaxial cables, copper wire and fiber optics, including the wires that comprise the bus 505, as well as the various components of the communications subsystem 530 (and/or the media by which the communications subsystem 530 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 510 retrieves and executes the instructions. The instructions received by the working memory 535 may optionally be stored on a non-transitory storage device 525 either before or after execution by the processor(s) 510.

FIG. 6 depicts a second device which may alternatively be used to implement any of the methods, steps, processes or algorithms previously disclosed herein. FIG. 6 includes one or more sensors 602 which can be used to sense engagement inputs and/or gesture inputs, and which provides sensor information regarding such inputs to a processor 604. The sensor 602 may comprise ultrasound technology (e.g., using microphones and/or ultrasound emitters), image or video capturing technologies such as a camera, IR or UV technology, magnetic field technology, emitted electromagnetic radiation technology, an accelerometer and/or gyroscope, and/or other technologies that may be used to sense an engagement input and/or a gesture input. In some embodiments, the sensor 602 comprises a camera configured to capture two-dimensional images. Such camera may be included in a cost-efficient system in some embodiments, and the use of input interpretation contexts may expand the number of commands that may be efficiently detected by the camera in some embodiments.

Processor 604 may store some or all sensor information in memory 606. Furthermore, processor 604 is configured to communicate with a module 608 for detecting engagement inputs, module 610 for selecting and activating input interpretation contexts, module 612 for detecting gesture inputs, and module 614 for determining and executing commands.

Additionally, each of the modules, 608, 610, 612 and 614 may have access to the memory 606. Memory 606 may include or interface with libraries, lists, arrays, databases, or other storage structures used to store sensor data, user preferences and information about input gesture interpretation contexts, actionable gesture inputs for each context, and/or commands corresponding to the different actionable gesture inputs. The memory may also store information about engagement inputs and the gesture input interpretation contexts corresponding to each engagement input. In FIG. 6, the modules 608, 610, 612, and 614 are illustrated separate from the processor 604 and the memory 606. In some embodiments, one or more of the modules 608, 610, 612, and 614 may be implemented by the processor 604 and/or in the memory 606.

In an example arrangement depicted in FIG. 6, the memory 606 contains an engagement input library 616, an input interpretation context library 618, a library of gesture inputs 620, and a library of commands 622. Each library may contain indices which enable modules 608, 610, 612 and 614 to identify the one or more elements as corresponding to one or more elements of another one of the libraries 616, 618, 620 and 622. Each of the modules 608, 610, 612 and 614, as well as processor 604 may have access to the memory 606 and each library therein, and may be capable of writing and reading data to and from the memory 606. Moreover, the processor 604 and module for determining and executing commands 614 may be configured to access and/or control the output component 624.

Libraries 616, 618, 620 and 622 may be hard encoded with information descriptive of the various actionable engagement inputs and their corresponding gesture input interpretation contexts, the gesture inputs associated with each context, and the commands linked to each such gesture input. Additionally, they may be supplemented with information provided by the user based on the user's preference, or may store information as determined by software or other medium executable by the device.

Certain components depicted in FIG. 6 may be understood as being configurable to perform certain of the steps which may be performed by components depicted in FIG. 5. For example, in certain embodiments of the device of FIG. 6, processor 604, in conjunction with modules 608, 610, 612 and 614, may be configured to perform certain steps described previously with regards to the discussion of processor(s) 510 in FIG. 5. Memory 606 may provide storage functionality similar to storage device(s) 525. Output component 624 may be configured to provide device outputs similar to those of output device(s) 520 in FIG. 5. Additionally, sensor 602 may be configured to enable certain functionality similar to functionality of input device(s) 515.

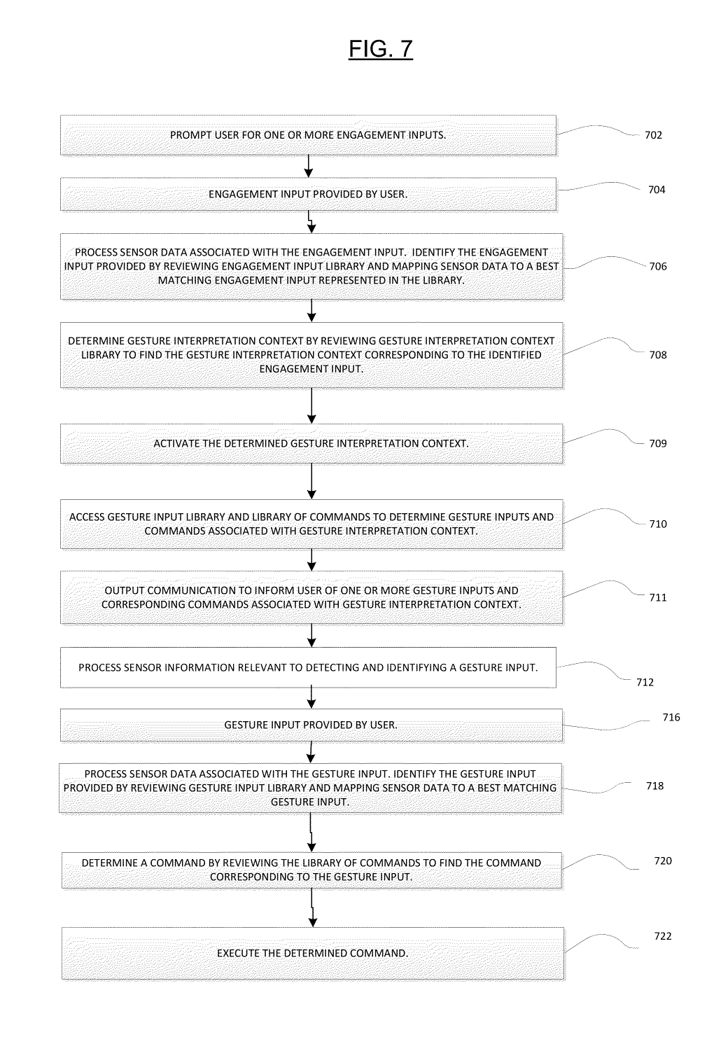

FIG. 7 depicts an example detailed algorithmic process which may be used by the device of FIG. 6 to implement certain methods according to the present disclosure. As depicted at 702, while the device 700 is in the limited detection mode, the processor 604 may signal output component 624 to prompt the user for one or more engagement inputs. The processor may interface with memory 606, and specifically, the engagement input library 616, to obtain information descriptive of the one or more engagement inputs for use in the prompt. Subsequently, the device remains in the limited detection mode and processor 604 continuously or intermittently processes sensor information relevant to detecting an engagement input.

At 704, sometime after being prompted, the user provides the engagement input. At 706, processor 604 processes sensor information associated with the engagement input. The processor 604 identifies the engagement input by using the module for detecting an engagement input 608 to review the engagement library and determining that the sensor information matches a descriptive entry in the engagement input library 616. As described generally, at 708, the processor 604 then selects a gesture input interpretation context by using the module for selecting an input interpretation context 610 to scan the input interpretation context library 618 for the gesture input interpretation context entry that corresponds to the detected engagement input. At 709, the processor 604 activates the selected gesture input interpretation context and activates the full detection mode.

At 710, the processor accesses the gesture input library 620 and the library of commands 622 to determine actionable gesture inputs for the active gesture input interpretation context, as well as the commands corresponding to these gesture inputs. At 711, the processor commands the output component 624 to output communication to inform the user of one or more of the actionable gesture inputs and corresponding commands associated with the active gesture input interpretation context.

At 712, the processor begins analyzing sensor information to determine if the user has provided a gesture input. This analysis may involve the processor using the module for detecting gesture inputs 612 to access the library of gesture inputs 620 for the purpose of determining if an actionable gesture input has been provided. The module for detecting gesture inputs 612 may compare sets of sensor information to descriptions of actionable gesture inputs in the library 620, and may detect a gesture input when a set of sensor information matches with one of the stored descriptions.

Subsequently, while the processor continues to analyze sensor information, the user provides a gesture input at 714. At 716, the processor, in conjunction with the module for detecting gesture inputs 612, detects and identifies the gesture input by determining a match with an actionable gesture input description stored in the library of gesture inputs and associated with the active gesture input interpretation context.

Subsequently, at 718, the processor activates the module 614 for determining and executing commands. The processor, in conjunction with module 614, for example, may access the library of commands 622 and find the command having an index corresponding to the previously identified gesture input. At 720, the processor executes the determined command.

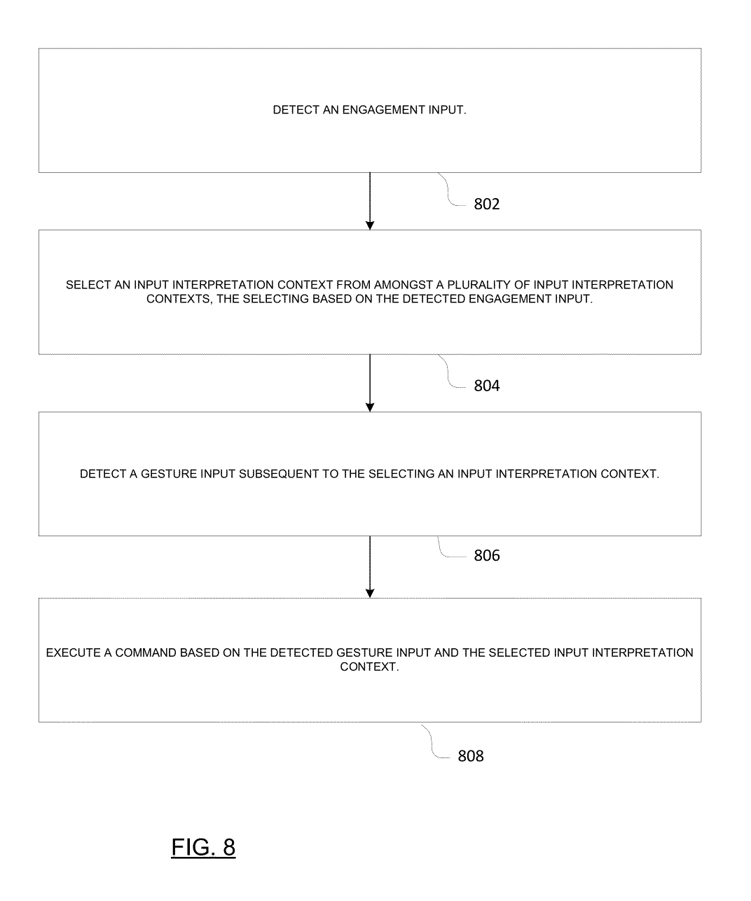

FIG. 8 is a flow diagram depicting example operations of a gesture recognition device in accordance with the present disclosure. As depicted, at 802, the device may detect an engagement input, for example using the module 608, the processor 604, data from the sensor 602, and/or the library 618. At 804, the device selects an input interpretation context from amongst a plurality of input interpretation contexts, for example using the module 610, the processor 604, the library 618, and/or the library 616. The selecting is based on the detected engagement input. In some embodiments, the engagement input detected at 802 is one of a plurality of engagement inputs, and each of the plurality of engagement inputs corresponds to a respective one of the plurality of input interpretation contexts. In such embodiments, the selecting at 804 may comprise selecting the input interpretation context corresponding to the detected engagement input. At 806, the device detects a gesture input subsequent to the selecting an input interpretation context, or example using the module 612, the processor 604, and/or the library 620. In some embodiments, the detection at 806 is based on the input interpretation context selected at 804. For example, one or more parameters associated with the selected input interpretation context may be used to detect the gesture input. Such parameters may be stored in the library 616, for example, or loaded into the library 620 or a gesture detection engine when the input interpretation context is selected. In some embodiments, a gesture detection engine may be initialized or activated, for example to detect motion when the engagement comprises a static pose. In some embodiments, a gesture detection engine is implemented by the module 612 and/or by the processor 604, and/or as described above. Potential gestures available in the selected input interpretation context may be loaded into the gesture detection engine in some embodiments, for example from the library 616 and/or 620. In some embodiments, detectable or available gestures may be linked to function, for example in a lookup table or the library 622 or another portion of the memory 606. In some embodiments, gestures for an application may be registered with the gesture detection engine, and/or hand or gesture models for certain gestures or poses may be selected or used or loaded based on the selection of the input interpretation context. At 808, the device executes a command based on the detected gesture input and the selected input interpretation context, for example using the module 614, the processor 604, and/or the library 622.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method comprising:
detecting an engagement input;
selecting an input interpretation context from amongst a plurality of input interpretation contexts, the selecting being done based on the detected engagement input;
detecting a gesture input subsequent to the selecting an input interpretation context; and
executing a command based on the detected gesture input and the selected input interpretation context.

2. The method of claim 1, wherein detecting an engagement input comprises detecting an engagement pose being maintained for a threshold amount of time.

3. The method of claim 2, wherein the engagement pose comprises a hand pose and wherein the hand pose comprises a substantially open palm and outstretched fingers.

4. The method of claim 2, wherein the engagement pose comprises a hand pose and wherein the hand pose comprises a closed first and an outstretched arm.

5. The method of claim 2, wherein the engagement pose comprises a hand pose, and wherein the selecting is independent of a position of the hand when the hand pose is detected.

6. The method of claim 1, wherein detecting an engagement input comprises detecting a gesture or an occlusion of a sensor.

7. The method of claim 1, wherein detecting an engagement input comprises detecting an audio engagement, the audio engagement comprising a word or phrase spoken by a user.

8. The method of claim 1, wherein the detected engagement input comprises one of a plurality of engagement inputs, each of the plurality of engagement inputs corresponding to a respective one of the plurality of input interpretation contexts, and wherein the selecting comprises selecting the input interpretation context corresponding to the detected engagement input.

9. The method of claim 1, further comprising:
in response to the detecting an engagement input, displaying a user interface which identifies an active input interpretation context.

10. The method of claim 1, further comprising:
providing audio feedback in response to the detecting an engagement input, wherein the audio feedback identifies an active input interpretation context.

11. The method of claim 1, wherein the selected input interpretation context is defined at an application level such that said selected input interpretation context is defined by an application that is in focus.

12. The method of claim 1, further comprising causing one or more elements to be displayed prior to detecting the engagement input, wherein the selecting is independent of the one or more elements being displayed.

13. The method of claim 1, wherein detecting the gesture input comprises detecting the gesture input based on one or more parameters associated with the selected input interpretation context.

14. The method of claim 1, further comprising ignoring sensor input irrelevant to detecting the engagement input, the ignoring done prior to detecting the engagement input.

15. The method of claim 1,
wherein detecting an engagement input comprises:
detecting a first engagement input associated with a first input interpretation context for controlling a first functionality; and
detecting a second engagement input associated with a second input interpretation context for controlling a second functionality different from the first functionality.

16. The method of claim 15, wherein the first functionality is associated with a first type of subsystem within an automobile control system, and wherein the second functionality is associated with a second type of subsystem within the automobile control system.

17. The method of claim 15, wherein the first functionality is associated with a first type of subsystem within a media player application, and wherein the second functionality is associated with a second type of subsystem within the media player application.

18. The method of claim 1, wherein the selected input interpretation context is globally defined.

19. The method of claim 1, wherein detecting the engagement input comprises detecting an initial engagement input and a later engagement input, and wherein detecting the later engagement input comprises using an input interpretation context associated with the initial engagement input.

20. An apparatus comprising:
an engagement detection module configured to detect an engagement input;
a selection module configured to select an input interpretation context from amongst a plurality of input interpretation contexts, the selection module being configured to perform the selecting based on the detected engagement input;
a detection module configured to detect a gesture input subsequent to the selection module selecting the input interpretation context; and
a processor configured to execute a command based on the detected gesture input and the selected input interpretation context.

21. The apparatus of claim 20, wherein the engagement detection module is configured to detect an engagement pose being maintained for a threshold amount of time.

22. The apparatus of claim 21, wherein the engagement pose comprises a hand pose and wherein the selection module is configured to select the input interpretation context independent of a position of the hand when the hand pose is detected.

23. The apparatus of claim 20, further comprising a display screen, wherein the processor is further configured to cause the display screen to display a user interface in response to detecting an engagement input, and wherein the user interface identifies an active input interpretation context.

24. The apparatus of claim 20, further comprising an audio speaker, wherein the processor is further configured to cause the audio speaker to output audio feedback in response to detecting an engagement input, wherein the audio feedback identifies an active input interpretation context.

25. The apparatus of claim 20, wherein the input interpretation context is defined at an application level such that the input interpretation context is defined by an application that is in focus.

26. The apparatus of claim 20, further comprising a camera configured to capture two-dimensional images, wherein the engagement detection module is configured to detect the engagement input based on at least one image captured by the camera, and wherein the detection module is configured to detect the gesture input using at least one other image captured by the camera.

27. The apparatus of claim 20, further comprising a sensor configured to input sensor data to the engagement detection module, and wherein the processor is further configured to cause the apparatus to ignore sensor data irrelevant to detecting an engagement input.

28. The apparatus of claim 20, wherein the engagement detection module is configured to:
detect a first engagement input associated with a first input interpretation context for controlling a first functionality, and
detect a second engagement input associated with a second input interpretation context for controlling a second functionality different from the first functionality, wherein the first functionality is associated with a first subsystem within an automobile control system or media player application, and wherein the second functionality is associated with a second subsystem within the automobile control system or media player application.

29. The apparatus of claim 20, wherein the detected engagement input comprises one of a plurality of engagement inputs, each of the plurality of engagement inputs corresponding to a respective one of the plurality of input interpretation contexts, and wherein the selection module is configured to select the input interpretation context corresponding to the detected engagement input.

30. The apparatus of claim 20, wherein the selected input interpretation context is globally defined.

31. The apparatus of claim 20, wherein detecting an engagement input comprises detecting an initial engagement input and a later engagement input, and wherein the detecting a later engagement input comprises using an input interpretation context selected based on the initial engagement input.

32. An apparatus comprising:
means for detecting an engagement input;
means for selecting an input interpretation context from amongst a plurality of input interpretation contexts, the selecting being based on the detected engagement input;
means for detecting a gesture input subsequent to the selecting an input interpretation context; and
means for executing a command based on the detected gesture input and the selected input interpretation context.

33. The apparatus of claim 32, wherein the means for detecting an engagement input comprise means for detecting an engagement pose being maintained for a threshold amount of time.

34. The apparatus of claim 33, wherein the engagement pose is a hand pose and wherein the means for selecting comprises means for selecting the input interpretation context independent of a position of the hand when the hand pose is detected.

35. The apparatus of claim 32, wherein the means for detecting an engagement input comprises means for detecting at least one of an engagement gesture, an occlusion of a sensor, or an audio engagement.

36. The apparatus of claim 32, further comprising:
means for providing feedback to a user of the apparatus in response to the selecting, wherein the feedback identifies the selected input interpretation context.

37. The apparatus of claim 32, wherein the detected engagement input comprises one of a plurality of engagement inputs, each of the plurality of engagement inputs corresponding to a respective one of the plurality of input interpretation contexts, and wherein the means for selecting comprises means for selecting the input interpretation context corresponding to the detected engagement input.

38. The apparatus of claim 32, wherein the means for selecting an input interpretation context comprise means for selecting an input interpretation context defined at an application level by an application that is in focus.

39. The apparatus of claim 32, wherein the means for detecting a gesture input comprise means for detecting a gesture input based on parameters associated with the selected input interpretation context.

40. The apparatus of claim 32, further comprising means for ignoring input irrelevant to detecting an engagement input prior to the means for detecting an engagement input detecting the engagement input.

41. The apparatus of claim 32,
wherein the means for detecting a gesture input comprises:
means for detecting a first engagement input associated with a first input interpretation context for controlling a first functionality of a system, and
means for detecting a second engagement input associated with a second input interpretation context for controlling a second functionality of the system different from the first functionality.

42. The apparatus of claim 32, wherein the means for selecting comprises means for selecting a globally defined input interpretation context.

43. The apparatus of claim 32, wherein the means for detecting an engagement input comprises means for detecting an initial engagement input and a later engagement input, and wherein means for detecting the later engagement input comprises means for using an input interpretation context associated with the initial engagement input to detect the later engagement input.

44. A non-transitory computer readable medium having instructions stored thereon, the instructions for causing an apparatus to:
detect an engagement input;
select, based on the detected engagement input, an input interpretation context from amongst a plurality of input interpretation contexts;
detect a gesture input subsequent to selection of the input interpretation context; and
execute a command based on the detected gesture input and the selected input interpretation context.
